(19) United States
(12) Patent Application Publication
(10) Pub. No.: US 2011/0311248 A1
(43) Pub. Date: Dec. 22, 2011

(54) IMAGE FORMING APPARATUS AND METHOD FOR CONTROLLING IMAGE DEFECT

(75) Inventor: Tatsuya Kitajima, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/161,658

(22) Filed: Jun. 16, 2011

Related U.S. Application Data
(60) Provisional application No. 61/355,818, filed on Jun. 17, 2010.

(51) Int. Cl. G03G 15/00; G03G 21/20; G03G 21/00

(52) U.S. Cl. 399/43; 399/44; 399/345; 399/92

(57) ABSTRACT

Disclosed is an image forming apparatus, including: a toner image forming unit that includes an image carrier forming toner images by supplying toner to formed electrostatic latent images and transferring the formed toner images; a cleaning member that is in contact with the image carrier and removes the toner remaining in the image carrier after the toner images are transferred; a spacing part that spaces the cleaning member from the image carrier; an environment information acquisition unit that acquires information regarding temperature or humidity that is environment information, in the toner image forming unit; an environment determination unit that determines whether the temperature or the humidity in the toner image forming unit satisfies a reference by using the environment information; and a control unit that controls the spacing part to space the cleaning member from the image carrier when it is determined that the temperature or the humidity in the toner image forming unit does not satisfy the reference.

### CROSS-REFERENCE TO RELATED APPLICATION

This application is based upon and claims the benefit of priority from U.S. provisional application 61/355,818, filed on Jun. 17, 2010; the entire contents of which are incorporated herein by reference.

### FIELD

Embodiments described herein relate generally to a technology of an electrophotographic image forming apparatus.

### BACKGROUND

In the electrophotographic apparatus of the related art, a photoconductor cleaning blade that removes a toner remaining in a photoconductor after toner images are transferred to a recording paper or an intermediate transfer belt is in contact with the photoconductor at all times. For this reason, wind currents around the photoconductor are interrupted by the cleaning blade, such that the temperature or humidity may be non-uniform around the photoconductor, for example, after continuous sheet feeding, or the like is performed. This affects the characteristics of the photoconductor to cause image defects such as image density unevenness.

### DESCRIPTION OF THE DRAWINGS

FIG. 1 is a diagram schematically showing an image forming apparatus according to the present embodiment.

FIG. 2 is a diagram schematically showing a fan included in the image forming apparatus according to the present embodiment.

FIG. 3 is a diagram schematically showing a toner image forming unit according to the image forming apparatus according to the present embodiment.

FIG. 4 is a diagram schematically showing a photoconductor drum and a cleaning blade according to the image forming apparatus of the present embodiment.

FIG. 5 is a diagram schematically showing the photoconductor drum and the cleaning blade according to the image forming apparatus of the present embodiment.

FIG. 6 is a diagram schematically showing a mechanism spacing the cleaning blade according to the image forming apparatus of the present embodiment.

FIG. 7 is a functional block diagram for suppressing non-uniformity of temperature and humidity in the toner image forming unit according to the image forming apparatus of the present embodiment.

FIG. 8 is a diagram showing an example of a processing flow of the spacing processing of the cleaning blade according to the image forming apparatus of the present embodiment.

FIG. 9 is a table for explaining calculation of time for spacing the cleaning blade according to the image forming apparatus of the present embodiment.

FIG. 10 is a timing chart of the spacing processing of the cleaning blade according to the image forming apparatus of the present embodiment.

### DETAILED DESCRIPTION

An image forming apparatus according to the present embodiment includes a toner image forming unit that includes an image carrier forming toner images by supplying toner to formed electrostatic latent images and transferring the formed toner images, a cleaning member that is in contact with the image carrier and removes the toner remaining in the image carrier after the toner images are transferred, a spacing part that spaces the cleaning member from the image carrier, an environment information acquisition unit that acquires information regarding temperature or humidity that is environment information, in the toner image forming unit, an environment determination unit that determines whether the temperature or the humidity in the toner image forming unit satisfies a reference by using the environment information acquired by the environment information acquisition unit, and a control unit that controls the spacing part to space the cleaning member from the image carrier if the environment determination unit determines that the temperature or the humidity in the toner image forming unit does not satisfy the reference.

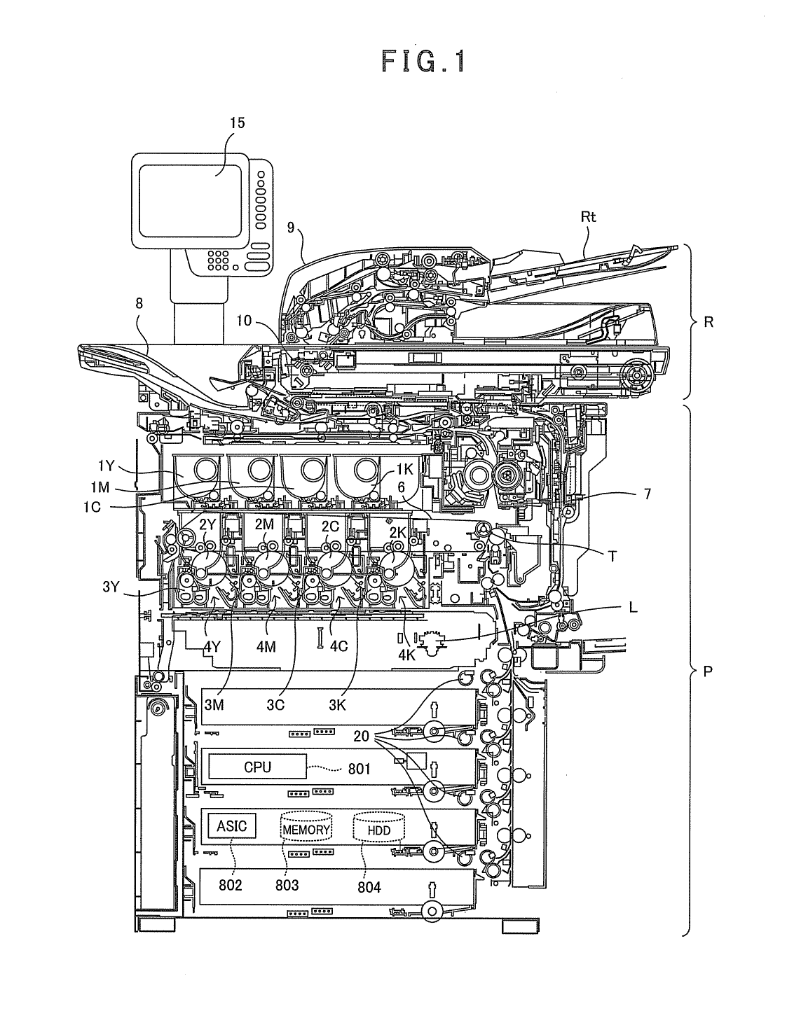

FIG. 1 is a longitudinal cross-sectional view schematically showing a configuration of a multi function peripheral (MFP) that is an example of an image forming apparatus according to the present embodiment.

As shown in FIG. 1, the image forming apparatus according to the present embodiment includes an image reading unit R and an image forming unit P.

The image reading unit R has a function of scanning and reading an image of a sheet document and a book document.

The image forming unit P has a function of forming toner images on a sheet based on an image read from a document by the image reading unit R, image data transmitted to the MFP from an external device, or the like.

The image reading unit R includes an auto document feeder (ADF) 9 that can automatically feed the document to a predetermined image reading position. The document loaded on a document tray Rt (a predetermined document loading stand) automatically fed by the auto document feeder 9 or the image of the document loaded on the document stand (not shown) are read by a scanning optical system 10.

Further, the image forming unit P includes a pick-up roller 20, toner image forming units 4Y to 4K that include photoconductor drums 2Y to 2K and development units 3Y to 3K, an intermediate transfer belt 6, a fixing device 7, a discharge tray 8, toner cartridges 1Y to 1K (colorant cartridge), and a laser unit L.

Further, the MFP according to a first embodiment includes a CPU 801, an application specific integrated circuit (ASIC) 802, a MEMORY 803, and a hard disk drive (HDD) 804 (see FIG. 1). The CPU 801 serves to perform a variety of processing in the MFP and also serves to realize various functions by executing programs temporarily stored in the MEMORY 803. Further, needless to say, the CPU 801 may be replaced with a micro processing unit (MPU) executing the same operation processing. Similarly, the HDD 804 may also be replaced with a memory device such as, a flash memory, or the like.

The ASIC 802 is mounted with hardware (circuit) that controls various functions included in the MFP.

The MEMORY 803 may be configured of, for example, a random access memory (RAM), a read only memory (ROM), a dynamic random access memory (DRAM), a static random access memory (SRAM), a video RAM (VRAM), or the like, and serves to temporarily store a variety of information or programsused in the MFP, log information of executed processing, or the like.

Further, the MFP according to the first embodiment includes a control unit 15 that enables a user to input requests for a variety of processes to the MFP. The control unit 15 is configured to include a power switch that switches a conducting state (ON/OFF) to the MFP from a power supply (not shown), a graphical display on which a touch panel sensor is mounted, frequently used processing input buttons such as numeric keys, start, cancel, or the like, a status display LED, or the like.

Hereinafter, copy processing that is an example of the processing in the MFP according to the first embodiment will be schematically described.

First, a sheet picked-up from a cassette by the pick-up roller 20 is supplied to a sheet feeding path. The sheet supplied to the sheet feeding path is fed in a predetermined feeding direction by a plurality of roller pairs.

Further, images of a plurality of sheet documents that are continuously and automatically fed by the auto document feeder 9 are read by the scanning optical system 10 at predetermined image reading positions.

Next, toner images are formed in toner image forming units 4Y, 4M, 4C, and 4K, based on the image data of the image read from the document by the image reading unit R.

First, electrostatic latent images are formed on photoconductive surfaces of photoconductor drums 2Y, 2M, 2C, and 2K for transferring toner images of yellow (Y), magenta (M), cyan (C), and black (K) to the sheet by a laser unit L.

Next, the toner is supplied to the photoconductive surfaces of the photoconductor drums 2Y to 2K on which the electrostatic latent images are formed from development units 3Y, 3M, 3C, and 3K. Thereby, the electrostatic latent images formed on the photoconductive surface of the photoconductor drums 2Y to 2M are developed (formation of toner images). These development units 3Y to 3K are supplied with toner by the toner cartridges 1Y to 1K.

Thereby, the toner images formed on the photoconductor drums 2Y to 2K are transferred (so-called primary transfer) to a surface of the intermediate transfer belt 6. Next, the toner images fed by the rotation of the intermediate transfer belt 6 are transferred to the fed sheet at a predetermined secondary position T.

The toner images transferred to the sheet are heated and fixed to the sheet by pressure using a heating roller in the fixing device 7.

The sheet on which a developer image is heated and fixed is fed to the feeding path by the plurality of feeding roller pairs and is sequentially discharged to the discharge tray 8.

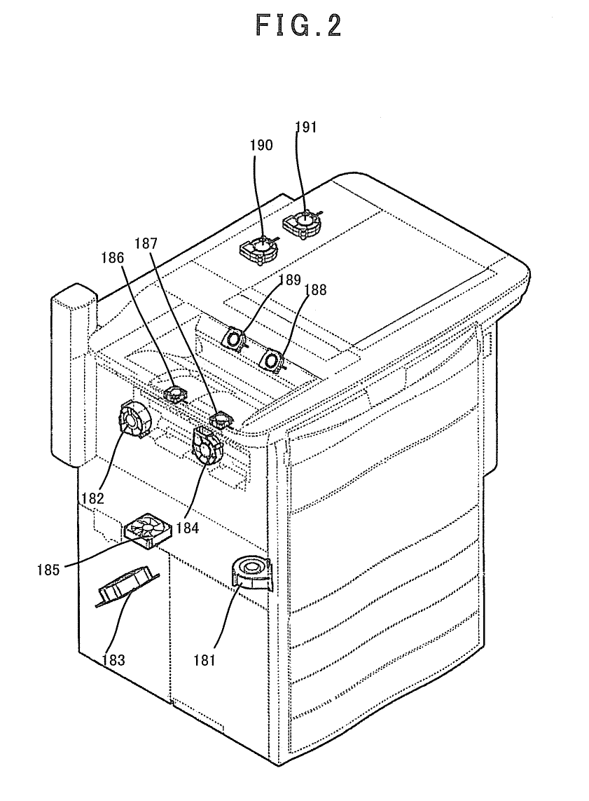

Further, in the present embodiment, as in the example shown in FIG. 2, the MFP includes a plurality of fans 181 to 191 that introduce air into the apparatus or discharge air in the apparatus. For example, a charging fan 185 (an ozone suction fan) has a function that sucks ozone generated at the time of charging the photoconductor drum and discharges the sucked ozone outside the apparatus, or the like.

Next, the toner image forming units 4Y, 4M, 4C, and 4K included in the MFP according to the present embodiment will be described. Further, since the toner image forming units have the same configuration to be described below, the toner image forming unit 4Y forming the yellow toner image will be described as an example below and the description of other toner image forming units will be omitted.

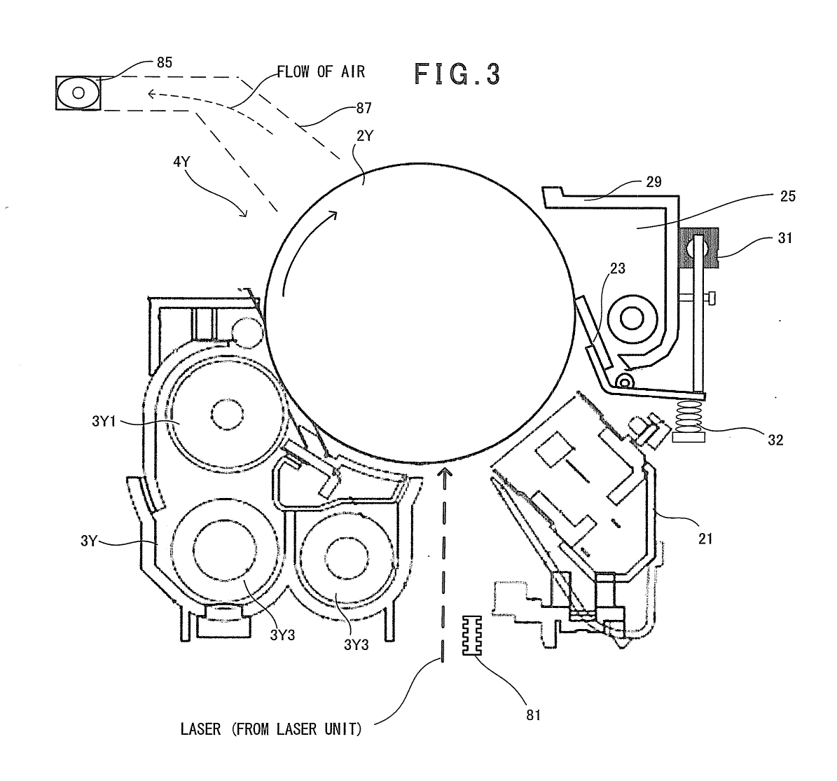

The toner image forming unit 4Y includes the photoconductor drum 2Y (corresponding to the image carrier). The photoconductive surface of the photoconductor drum 2Y is formed with the electrostatic latent image and the toner image by supplying the toner to the electrostatic latent image. As shown in FIG. 3, the photoconductor drum 2Y has an organic photoconductor (OPC) formed on a surface of a support member and rotates in an arrow direction. The formed toner image is transferred to the intermediate transfer belt 6. In addition, another embodiment may have a configuration in which the toner images are transferred to a sheet from the photoconductor drum 2Y.

Further, in the present embodiment, the toner image forming unit 4Y includes a charger unit 21, the development unit 3Y, a cleaner unit 25 having a cleaning blade 23, and a neutralization LED 27 that are disposed around the photoconductor drum 2Y, in addition to the photoconductor drum 2Y.

The charger unit 21 is applied with voltage (charging grid bias) to uniformly charge the surface (the photoconductive surface) of the image carrier. The photoconductive surface of the charged photoconductor drum 2Y is subjected to image exposure by the laser unit L according to an image signal. Thereby, the electrostatic latent image is formed on the photoconductor drum 2Y.

The development unit 3Y is applied with voltage (development bias) to form the toner image by developing the electrostatic latent image on the photoconductor drum 2Y. In detail, the toner in the developer agitated by a mixer 3Y1 is supplied to the photoconductor drum 2Y on which the electrostatic latent image is formed by a development roller (so-called magnet roller) 3Y3.

The toner image formed on the photoconductor drum 2Y is transferred (primary transfer) to the intermediate transfer belt 6.

Further, the toner (the residual toner after transfer) remaining on the photoconductor drum 2Y after the primary transfer is performed is cleaned by the cleaner unit 25. The photoconductor drum 2Y is neutralized by the neutralization LED 27 and is used to form the next electrostatic latent image.

The cleaner unit 25 of the present embodiment includes the cleaning blade 23 (corresponding to the cleaning member) and a cleaner housing 29.

The cleaning blade 23 is in contact with the surface of the photoconductor drum 2Y to scrape the residual toner after transfer and is guided to the cleaner housing 29.

The cleaner housing 29 (accommodation part) has an opening part at a side opposite to the photoconductive surface and accommodates the residual toner scraped down from the photoconductive surface of the photoconductor drum 2Y by the cleaning blade 23.

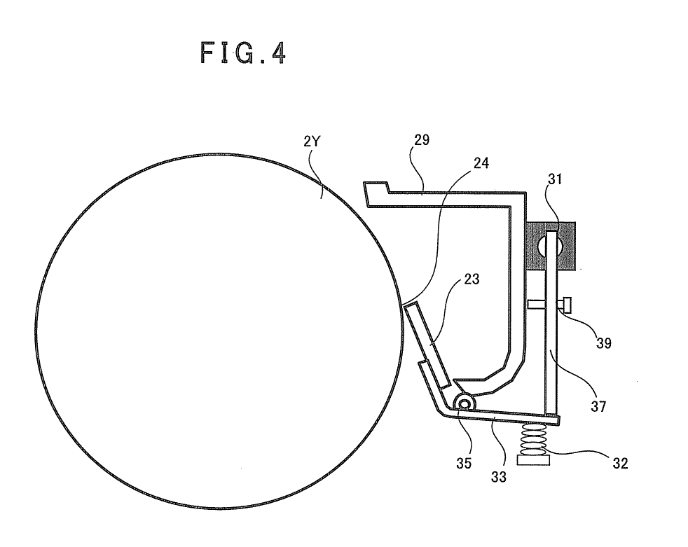

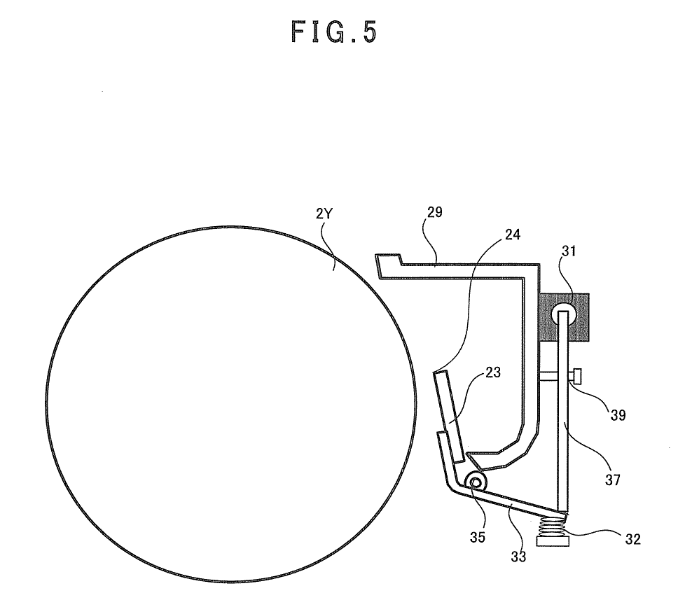

As shown in FIG. 4, a spring that biases the cleaning blade to be in contact with the photoconductor drum 2Y, a solenoid 31, a connection member disposed between the spring and the solenoid 31 and the cleaning blade 23 are disposed around the cleaning blade 23. In the present embodiment, as shown in FIG. 5, the photoconductor drum 2Y is spaced by the connection member according to the control of the solenoid 31. In the present embodiment, the solenoid 31 and the connection member correspond to the spacing part.

As shown in FIG. 5, since the flow of air interrupted by the cleaning blade by spacing the cleaning blade from the photoconductor drum 2Y is generated, the tendency toward humidity occurring between the inside of the cleaner housing 29 and the lower portion of the cleaning blade 23 may be eliminated. As a result, it is possible to suppress the non-uniformity of temperature and humidity in the toner image forming unit 4Y.

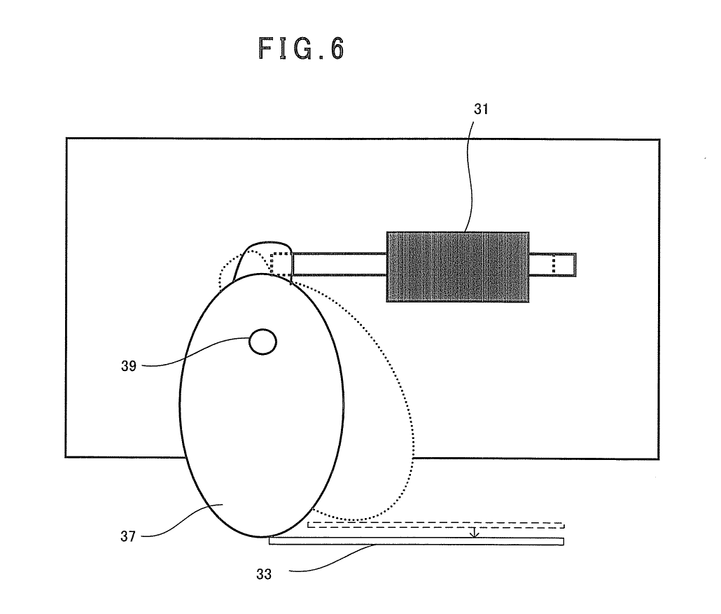

In the present embodiment, the cleaning blade 23 is made of an elastomer such as urethane rubber, or the like, that is molded in a blade shape and is fixed to a support member 33. The support member 33 is disposed so as to rotate around a rotation supporting point 35. The support member 33 is biased by a spring 32 and thus, the cleaning blade 23 is biased to be in contact with the surface of the photoconductor drum 2Y. Further, the support member 33 is connected to a spacing blade 37 and the spacing blade 37 is disposed so as to rotate around a rotation supporting point 39. The spacing blade 37 is connected to the solenoid 31 and the spacing blade 37 rotates around the rotation supporting point 39 as shown in FIG. 6 by operating the solenoid 31. As a result, a contact portion 24 (hereinafter, simply referred to as the contact portion 24) to the photoconductor drum 2Y of the cleaning blade 23 fixed to the support member 33 rotates around the rotation supporting point 35. Thereby, the cleaning blade 23 is spaced from the photoconductor drum 2Y.

As described above, it is possible to suppress the non-uniformity of temperature and humidity while a space necessary for the configuration that can implement the spacing operation is made small by implementing the configuration of spacing by rotating the contact portion 24 around the rotation supporting point.

The toner image forming unit 4Y is disposed with an intake port of a duct 87 and air around the photoconductor drum 2Y is discharged outside the apparatus by driving the charging fan 185 by a driving motor (not shown).

Further, in the present embodiment, the toner image forming unit 4Y is disposed with a temperature and humidity sensor 81 that measures temperature and humidity.

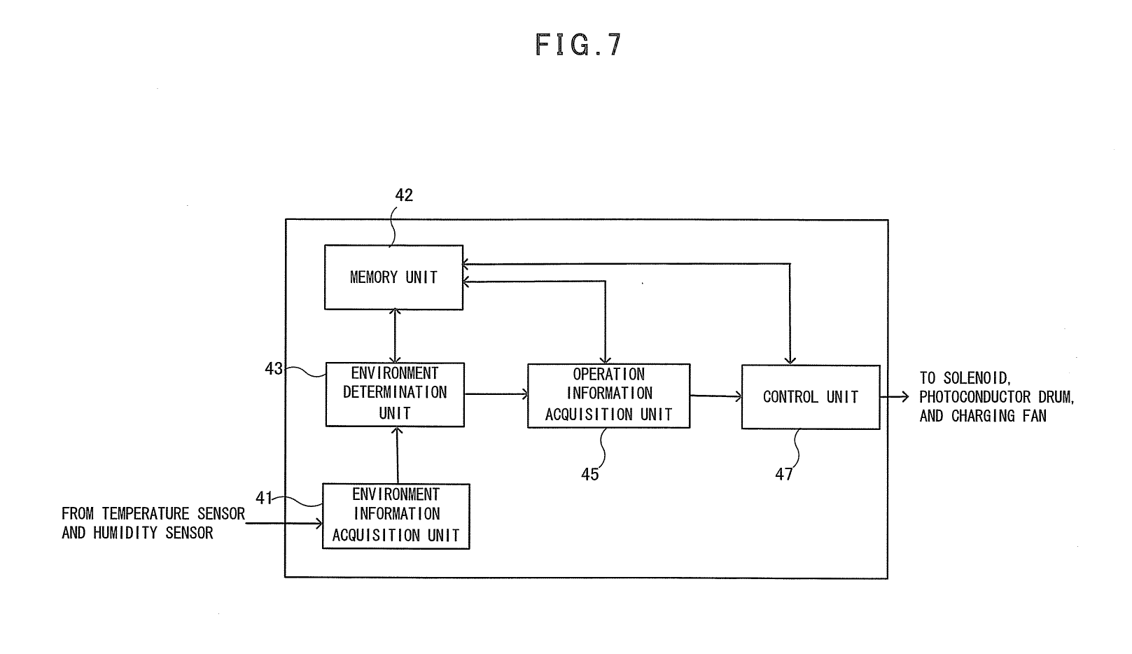

Next, in the image forming apparatus of the present embodiment, a functional block regarding the suppression of the non-uniformity of temperature and humidity in the toner image forming unit will be described with reference to FIG. 7. The image forming apparatus of the present embodiment includes a memory unit 42, an environment information acquisition unit 41, an environment determination unit 43, an operation information acquisition unit 45, and a control unit 47. Each functional block may be realized by executing a program read from the memory 803 by the CPU 801, for example.

The memory unit 42 is stored with driving frequency information, information regarding the number of printing sheets, printing job frequency information, environment reference information, and spacing time information.

In this case, the driving frequency information is information regarding number of rotations of the photoconductor drum from the start of use.

The information regarding the number of printing sheets is information regarding the number of printing sheets in an ending one printing job. In more detail, the information regarding the number of printing sheets is information regarding the number of printing sheets in the one printing job immediately before the spacing from the photoconductor drum of the cleaning blade is executed.

The printing job frequency information is information regarding the frequency executing the printing job. In more detail, the printing job frequency information is information regarding the frequency of the printing job continuously executed without performing the execution of the spacing control of the cleaning member by the control unit 47, the stop of the image forming apparatus, the stop of the fixing device, or the like during performing the printing job.

Further, the driving frequency information, the information regarding the number of printing sheets, and the printing job frequency information are updated by the CPU 801 based on the recording (log) stored in the memory every time the printing job is executed.

Further, the information regarding the number of printing sheets is reset (cleared to zero) by the CPU 801 every time a new printing job is executed. The printing job frequency information may be reset (cleared to zero) by the CPU 801 every time the spacing control of the cleaning member is performed by, for example, the control unit 47. Further, in addition to the execution of the spacing control by the control unit 47, for example, the resetting (clearing to zero) may also be made according to the stop of the image forming apparatus or the fixing device.

The environment reference information is information regarding a reference of temperature or humidity in the toner image forming unit. The reference may be appropriately set by those skilled in the art according to the detailed configuration of the apparatus, or the like. For example, the case in which the temperature and the humidity are in a predetermined range may be set as the reference. In detail, the temperature may be set to be in 23±5° C. (18 to 28° C.) and the humidity may be set to be in 50±10 RH % (40 to 60 RH %).

The spacing time calculation information is information for calculating time for which the cleaning member is spaced from the photoconductor drum. In more detail, in order to calculate the spacing time, a calculating equation and the information regarding coefficients in the calculating equation may be listed.

The environment information acquisition unit 41 acquires the information (referred to as environment information) on temperature or humidity in the toner image forming unit from the temperature and humidity sensor 81. The environment information acquisition unit 41 transmits the acquired environment information to the environment determination unit 43.

The environment determination unit 43 determines whether the temperature and the humidity in the toner image forming unit satisfy the reference based on the environment reference information stored in the memory unit 42 by using the environment information acquired in the environment information acquisition unit 41. When the environment determination unit 43 determines that at least any one of the temperature and the humidity in the toner image forming unit does not satisfy the reference, it transmits the determination results to the operation information acquisition unit 47.

When the environment determination unit 43 determines that at least any one of the temperature and the humidity in the toner image forming unit does not satisfy the reference, the operation information acquisition unit 45 acquires the driving frequency information, the information regarding the number of printing sheets, and the printing job frequency information that are stored in the memory 42. The operation information acquisition unit 45 transmits the acquired driving frequency information, information regarding the number of printing sheets, and printing job frequency information to the control unit 47.

The control unit 47 controls the driving of the solenoid to contact or space the cleaning blade to or from the photoconductor drum. When the control unit 47 acquires the driving frequency information, the information regarding the number of printing sheets, and the printing job frequency information, that is, when it is determined that at least any one of the temperature or the humidity does not satisfy the reference, the control unit 47 spaces the cleaning blade from the photoconductor drum.

In the present embodiment, the control unit 47 acquires the spacing time information that is information regarding the time for which the cleaning blade is spaced from the photoconductor drum by using the driving frequency information, the information regarding the number of printing sheets, and the printing job frequency information and spaces the cleaning blade from the photoconductor drum for the time represented by the spacing time information.

In detail, the control unit 47 acquires the spacing time information by calculating the spacing time based on the spacing time calculation information stored in the memory unit 42 by using the driving frequency information, the information regarding the number of printing sheets, and the printing job frequency information.

Further, in the present embodiment, the control unit 47 rotates the photoconductor drum when the environment determination unit 43 determines that at least any one of the temperature and the humidity in the toner image forming unit does not satisfy the reference.

In addition, in the present embodiment, the control unit drives the charging fan 185 by controlling a motor (not shown) of the charging fan 185 to execute the exhaust processing of the toner image forming unit by the charging fan 185 when the environment determination unit 43 determines that at least any one of the temperature and the humidity in the toner image forming unit does not satisfy the reference.

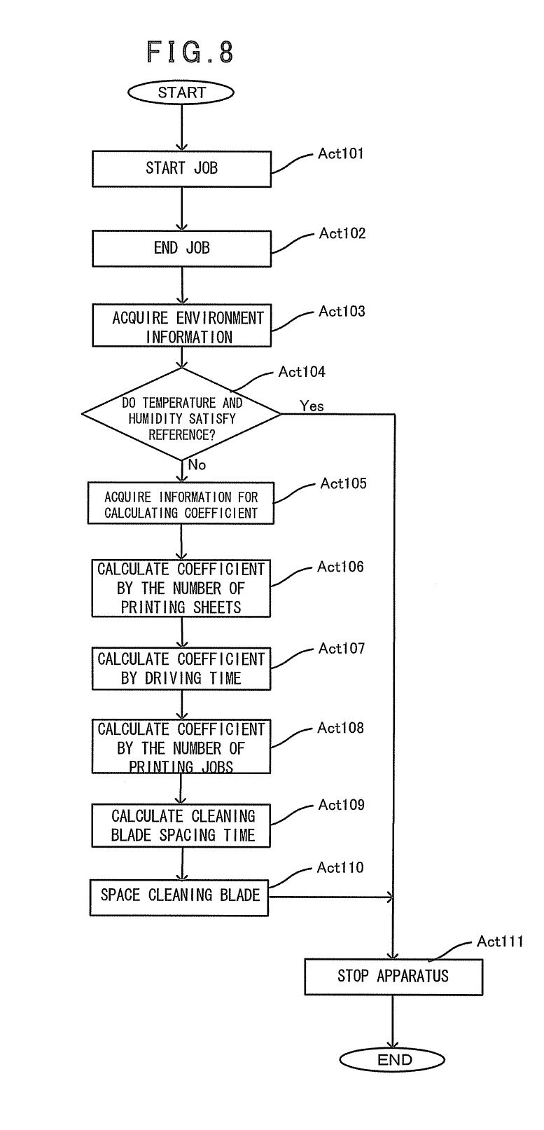

Next, FIG. 8 is a diagram showing an example of a processing flow according to the suppression of the non-uniformity of temperature and humidity in the toner image forming unit in the image forming apparatus of the present embodiment.

Further, in the following description, an example of the starting factors of suppressing the non-uniformity processing of temperature and humidity may include the execution of the printing job and the stop of the apparatus. Without being limited thereto, only the execution of the printing job may be considered as the starting factor. Further, the number of printing sheets in the one printing job executed immediately before, the printing rate, the job history, the temperature or the humidity in the toner image forming unit, the driving time of the photoconductor drum, or the like, is set as the reference. Meanwhile, ones exceeding the reference may be set as the starting factor.

First, in Act 101, the image forming apparatus starts the printing job based on the request from the user. Next, in Act 102, the image forming apparatus ends the job.

In Act 103, the environment information acquisition unit 41 acquires the environment information. Next, in Act 104, the environment determination unit 43 determines whether the temperature and the humidity satisfy the reference based on the environment information. For example, the environment determination unit 43 determines whether the temperature in the toner image forming unit is in the range of 23±5° C. and whether the humidity is in the range of 50±10 RH %.

In Act 104, when it is determined that the temperature and the humidity satisfy the reference, the image forming apparatus proceeds to Act 111 and stops as it is, such that the processing ends.

Meanwhile, in Act 104, when it is determined that the temperature and the humidity do not satisfy the reference, in Act 105, the operation information acquisition unit 45 acquires the driving frequency information, the information regarding the number of printing sheets, and the printing job frequency information from the memory unit 42 (acquires the information for calculating the coefficients).

In Act 106 to Act 108, the control unit 47 executes the calculation of the coefficients used for calculating the spacing time by using the spacing time calculation information stored in the memory unit 42.

In detail, in Act 106, the controller 47 calculates the coefficients regarding the number of printing sheets by using the information regarding the number of printing sheets. In Act 107, the controller 47 calculates the coefficients regarding the driving frequency of the photoconductor drum by using the driving frequency information. In Act 108, the control unit 47 calculates the coefficients regarding the frequency executing the printing job by using the printing job frequency information.

In Act 109, the control unit 47 calculates the time for which the cleaning blade is spaced from the photoconductor drum by using the coefficients calculated in Act 106 to Act 108.

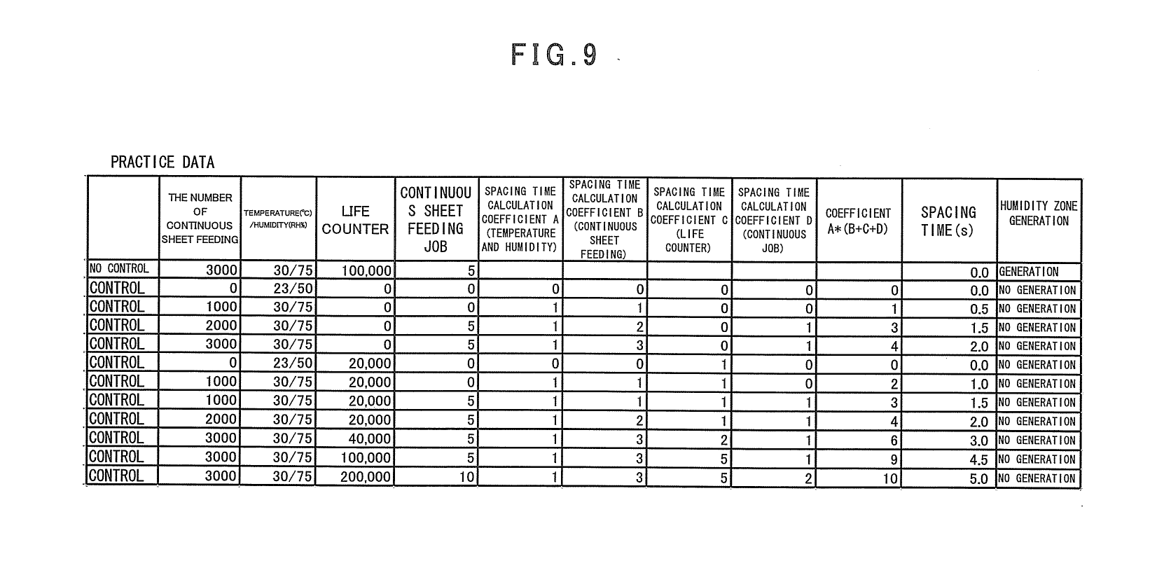

FIG. 9 is a table showing results when the calculation of the spacing time is performed as an example based on the present embodiment.

In FIG. 9, the number of continuous sheet feeding is represented by the information regarding the number of printing sheets. The number of continuous sheet feeding means the number of printed sheets in the printing job executed in Act 101. The temperature (° C.)/the humidity (RH %) mean the temperature and the humidity represented by the environment information. A life counter means the number of rotations of the photoconductor drum after the start of use represented by the driving frequency information. The continuous sheet feeding job means the printing job frequency (in detail, the frequency of the printing job continuously executed after the execution of the spacing control of the cleaning blade or the stop of the apparatus by the control unit 47 as the reference) represented by the printing job frequency information.

Further, in FIG. 9, coefficient A is a coefficient selected based on the environment information. When at least any one of the temperature and the humidity is out of the predetermined range, 1 is selected as the coefficient. Coefficient B is a coefficient selected according to the information regarding the number of printing sheets and for the number of sheets printed by the one printing job, the coefficient is selected at five stages of 1 to 5 using 1000 sheets as one unit. Coefficient C is a coefficient selected according to the driving frequency information and for the number of rotations of the photoconductor drum, the coefficient is selected at five stages of 1 to 5 using 20000 rotations as one unit. Coefficient D is a coefficient selected according to the printing job frequency information and for the frequency of the printing job, the coefficient is selected at five stages of 1 to 5 using the five-time printing job as one unit.

In the present embodiment, the time for which the cleaning blade is spaced is calculated based on coefficients A to D selected as described above. In detail, the spacing time is calculated using the following equation.

ST=0.5×A×(B+C+D)

where ST: time for which cleaning blade is spaced (second)

A to D: coefficients A to D

Further, as shown in FIG. 9, when spacing the cleaning blade for the calculated time, the occurrence of the image density unevenness referred to as the humidity zone which indicates that the temperature or the humidity in the toner image forming unit is non-uniform is not admitted. In FIG. 9, for convenience of understanding, an example of the image forming apparatus according to the related art that does not execute the spacing of the cleaning member shown in the present embodiment and an example (coefficient A is shown as 0) of the case in which the temperature and the humidity in the toner image forming unit are in the predetermined range are shown together.

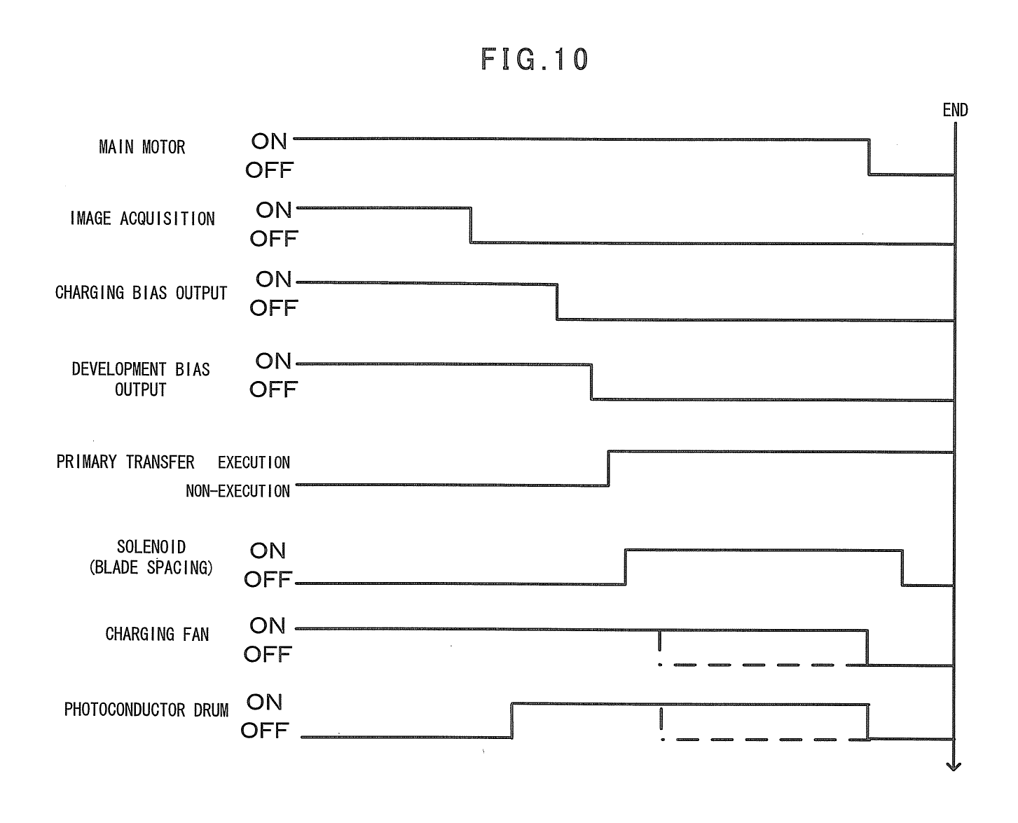

In Act 110, the control unit 47 spaces the cleaning blade from the photoconductor drum based on the spacing time calculated in Act 109. Further, the control unit 47 drives the charging fan 185 while rotating the photoconductor drum according to the spacing of the cleaning blade. For example, as shown in FIG. 10, when the cleaning blade is spaced, even after the primary transfer of the toner image to the intermediate transfer belt 6 is executed, the control unit drives the charging fan 185 while rotating the photoconductor drum for a longer time (solid line) than the case in which the contact to the photoconductor drum of the cleaning blade is maintained (broken line).

As described above, according to the image forming apparatus of the present embodiment, air more smoothly flows by contacting or spacing the cleaning blade to or from the photoconductor drum according to the temperature and the humidity in the toner image forming unit. For this reason, it is possible to prevent the image density unevenness, or the like, from occurring by suppressing the case in which the temperature and the humidity in the toner image forming unit are non-uniform.

In addition, the scraping of the photoconductor drum or the cleaning blade may be suppressed and the lifespan may be extended by spacing the cleaning blade from the photoconductor drum.

Further, the non-uniformity of temperature and humidity may be further suppressed by rotating the photoconductor drum while driving the charging fan 185 by spacing the cleaning blade from the photoconductor drum.

### Other Embodiments

As described above, although one embodiment is described, other embodiments may be implemented without being limited thereto.

For example, the present embodiment shows the configuration of spacing the cleaning blade from the photoconductor drum. Without being limited thereto, for example, the spacing of the cleaning blade from the photoconductor drum by separating the cleaning unit from the photoconductor drum may also be permitted.

Further, the present embodiment describes the case of contacting or spacing the cleaning blade to or from the photoconductor drum by using the information regarding the temperature and the humidity. Without being limited thereto, the contacting or the spacing of the cleaning blade to or from the photoconductor drum by using the information regarding at least one of the temperature and the humidity may be permitted. That is, it is possible to contact or space the cleaning blade to or from the photoconductor drum according to whether the temperature or the humidity in the toner image forming unit satisfies the reference.

Further, driving only one of the charging fan and the photoconductor drum may be permitted according to the spacing of the cleaning blade.

Further, for the calculating of the spacing time, other aspects may be put into practice. For example, the control unit acquires the spacing time information that is the information regarding the time for which the cleaning member is spaced from the image carrier by using at least any one of the environment information, the driving frequency information, the information regarding the number of printing sheets, and the printing job frequency information when the environment determination unit determines that the temperature or the humidity in the toner image forming unit does not satisfy the reference and spaces the cleaning member from the image carrier for the time represented by the spacing time information. The spacing time information may be calculated based on at least one of the environment information, the driving frequency information, the information regarding the number of printing sheets, and the printing job frequency information. Further, the spacing time information may acquire the spacing time information stored in the predetermined memory region corresponding to the information by using at least one of the environment information, the driving frequency information, the information regarding the number of printing sheets, and the printing job frequency information. Further, the operation information acquisition unit may acquire at least one of the driving frequency information, the information regarding the number of printing sheets, and the printing job frequency information.

Further, in the present embodiment, the cleaning blade contacts or is spaced from the photoconductor drum based on the temperature or the humidity. As other embodiments, at least one of the environment information, the driving frequency information, the information regarding the number of printing sheets, and the printing job frequency information may be acquired and the spacing time for which the cleaning blade is spaced from the photoconductor drum may be calculated by using at least any one of the acquired environment information, driving frequency information, information regarding the number of printing sheets, and printing job frequency information. Further, the spacing time is a concept including 0. When the spacing time is 0, the cleaning blade is in contact with the photoconductor drum. Further, the control unit controls the spacing part and contacts or spaces the cleaning member to and from the image carrier according to the spacing time calculated by the spacing time calculation unit.

Further, the functional blocks (the information acquisition unit acquiring at least one of the environment information, the driving frequency information, the information regarding the number of printing sheets, and the printing job frequency information, the spacing time calculation unit calculating the spacing time, the control unit contacting or spacing the cleaning blade) in other embodiments may be realized by, for example, executing a program read from the memory 803 by the CPU 801.

As described above, according to the technology described herein, it is possible to suppress the occurrence of the image defects such as the image density unevenness, or the like, by suppressing the non-uniformity of the temperature and the humidity in the toner image forming unit (around the photoconductor).

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and method described herein may be made without departing from the sprit of the inventions. The accompanying claims and their equivalents are intended to cover such forms or modifications as would fall within the scope and spirit of the inventions.

What is claimed is:

1. An image forming apparatus, comprising:
a toner image forming unit that includes an image carrier forming toner images by supplying toner to formed electrostatic latent images and transferring the formed toner images;
a cleaning member that is in contact with the image carrier and removes the toner remaining in the image carrier after the toner images are transferred;
a spacing part that spaces the cleaning member from the image carrier;
an environment information acquisition unit that acquires information regarding temperature or humidity that is environment information, in the toner image forming unit;
an environment determination unit that determines whether the temperature or the humidity in the toner image forming unit satisfies a reference by using the environment information acquired by the environment information acquisition unit; and
a control unit that controls the spacing part to space the cleaning member from the image carrier if the environment determination unit determines that the temperature or the humidity in the toner image forming unit does not satisfy the reference.

2. The apparatus according to claim 1, further comprising an operation information acquisition unit acquiring at least one of driving frequency information that is information regarding a driving frequency from the start of use of the image carrier, information regarding the number of printing sheets that is information regarding the number of printing sheets in an ending one printing job, and printing job frequency information that is information regarding a frequency of a printing job,
wherein the control unit acquires spacing time information that is information regarding the time for which the cleaning member is spaced from the image carrier by using at least any one of the environment information, the driving frequency information, the information regarding the number of printing sheets, and the printing job frequency information and spaces the cleaning member from the image carrier for the time represented by the spacing time information, when the environment determination unit determines that at least any one of the temperature and the humidity in the toner image forming unit does not satisfy the reference.

3. The apparatus according to claim 1, further comprising an operation information acquisition unit that acquires driving frequency information that is information regarding a driving frequency from the start of use of the image carrier, information regarding the number of printing sheets that is information regarding the number of printing sheets in an ending one printing job, and printing job frequency information that is information regarding a frequency of a printing job
wherein the control unit acquires spacing time information that is information regarding time for which the cleaning member is spaced from the image carrier by using the driving frequency information, the information regarding the number of printing sheets, and the printing job frequency information and spaces the cleaning member from the image carrier for the time represented by the spacing time information.

4. The apparatus according to claim 1, wherein the image carrier is a photoconductor drum that is rotatably disposed, and
the control unit rotates the photoconductor drum while spacing the cleaning member from the image carrier when the environment determination unit determines that at least one of the temperature and the humidity in the toner image forming unit does not satisfy the reference.

5. The apparatus according to claim 1, further comprising an exhaust unit that exhausts air in the toner image forming unit outside the apparatus,
wherein the control unit executes the exhaust processing by the exhaust unit while spacing the cleaning member from the image carrier when the environment determination unit determines that at least one of the temperature and the humidity in the toner image forming unit does not satisfy the reference.

6. The apparatus according to claim 1, wherein the spacing part spaces the cleaning member from the image carrier by rotating the contact portion of the cleaning member contacting the image carrier around a supporting point.

7. A method for controlling an image defect in an image forming apparatus including a toner image forming unit that includes an image carrier forming toner images by supplying toner to formed electrostatic latent images and transferring the formed toner images, a cleaning member that is in contact with the image carrier and removes the toner remaining in the image carrier after the toner images are transferred, and a spacing part that spaces the cleaning member from the image carrier, the method comprising:
acquiring environment information that is information regarding temperature or humidity in the toner image forming unit;
determining whether the temperature or the humidity in the toner image forming unit satisfies a reference by using the environment information; and
controlling the spacing part to space the cleaning member from the image carrier when it is determined that the temperature or the humidity in the toner image forming unit does not satisfy the reference.

8. The method according to claim 7, further comprising acquiring, by an operation information acquisition unit, at least one of driving frequency information that is information regarding a driving frequency from the start of use of the image carrier, information regarding the number of printing sheets that is information regarding the number of printing sheets in an ending one printing job, and printing job frequency information that is information regarding a frequency of a printing job,
acquiring spacing time information that is information regarding the time for which the cleaning member is spaced from the image carrier by using at least any one of the environment information, the driving frequency information, the information regarding the number of printing sheets, and the printing job frequency information and spacing the cleaning member from the image carrier for the time represented by the spacing time information, when it is determined that at least any one of the temperature and the humidity in the toner image forming unit does not satisfy the reference.

9. The method according to claim 7, further comprising acquiring driving frequency information that is information regarding a driving frequency from a start of use of the image carrier, information regarding the number of printing sheets that is information regarding the number of printing sheets in an ending one printing job, and printing job frequency information that is information regarding a frequency of a printing job,
acquiring spacing time information that is information regarding time for which the cleaning member is spaced from the image carrier by using the driving frequency information, the information regarding the number of printing sheets, and the printing job frequency information and spacing the cleaning member from the image carrier for the time represented by the spacing time information.

10. The method according to claim 7, further comprising rotating the photoconductor drum while spacing the cleaning member from the image carrier when it is determined that at least one of the temperature and the humidity in the toner image forming unit does not satisfy the reference,
wherein the image carrier in the image forming apparatus is a photoconductor drum that is rotatably disposed.

11. The method according to claim 7, further comprising executing the exhaust processing by the exhaust unit while spacing the cleaning member from the image carrier when it is determined that at least one of the temperature and the humidity in the toner image forming unit does not satisfy the reference,
wherein the image forming apparatus includes an exhaust unit that exhausts air in the toner image forming unit outside the apparatus.

12. An image forming apparatus, comprising:
a toner image forming unit that includes an image carrier forming toner images by supplying toner to formed electrostatic latent images and transferring the formed toner images;
a cleaning member that is in contact with the image carrier and removes the toner remaining in the image carrier after the toner images are transferred;
a spacing part that spaces the cleaning member from the image carrier;
an information acquisition unit that acquires at least one of environment information that is information regarding temperature or humidity in the toner image forming unit, driving frequency information that is information regarding a driving frequency from the start of use of the image carrier, information regarding the number of printing sheets that is information regarding the number of printing sheets in an ending one printing job, and printing job frequency information that is information regarding a frequency of a printing job;
a spacing time calculation unit that calculates the spacing time for which the cleaning member is spaced from the image carrier by using any one of the environment information, the driving frequency information, the information regarding the number of printing sheets, and the printing job frequency information that are acquired by the information acquisition unit; and
a control unit that controls the spacing part and contacts and spaces the cleaning member to and from the image carrier according to spacing time calculated by the spacing time calculation unit.
